(19) United States
(12) Patent Application Publication
(10) Pub. No.: US 2018/0329686 A1
(43) Pub. Date: Nov. 15, 2018

(54) OPTIMIZED INTEGER DIVISION CIRCUIT

(71) Applicant: Oracle International Corporation, Redwood Shores, CA (US)

(72) Inventors: Jo C. Ebergen, San Francisco, CA (US); Dmitry Ju Nadezhin, Moscow (RU); Christopher H. Olson, Austin, TX (US); Jeffrey S. Brooks, Austin, TX (US)

(73) Assignee: Oracle International Corporation, Redwood Shores, CA (US)

(21) Appl. No.: 15/816,403

(22) Filed: Nov. 17, 2017

(30) Foreign Application Priority Data
May 12, 2017 (RU) 2017116684

(51) Int. Cl. G06F 7/537

(52) U.S. Cl. CPC G06F 7/5375

(57) ABSTRACT

The disclosed embodiments relate to the design of an integer division circuit, which comprises: a dividend-input that receives an integer dividend A; a divisor-input that receives an integer divisor B; a quotient-output that outputs an integer quotient q; and a division engine that executes the Goldschmidt method to divide A by B to produce q. During a pre-processing operation, which commences executing before the Goldschmidt method starts executing, the division engine determines whether A<B. If A<B, the division engine sets q=0 without having to execute the Goldschmidt method.

### RELATED APPLICATION

This application hereby claims priority under 35 U.S.C. § 119 to Russian Patent Application Serial No. 2017116684 filed 12 May 2017, which is incorporated by reference herein in its entirety.

### BACKGROUND

### Field

The disclosed embodiments generally relate to circuits for performing division operations in computer systems. More specifically, the disclosed embodiments relate to an optimized design for a circuit that performs an integer division operation based on the Goldschmidt method.

### Related Art

In order to keep pace with increasing microprocessor clock speeds, computational circuitry within the microprocessor core must perform computational operations at increasingly faster rates. One of the most time-consuming computational operations performed within a computer system is a division operation. A division operation involves dividing a dividend, A, by a divisor, B, to produce a quotient, q, wherein q=A/B.

Computer systems often perform division operations by using a variation of the Goldschmidt method, which operates by iteratively multiplying both the dividend and divisor by a common factor Fᵢ, chosen such that the divisor converges to 1. This causes the dividend to converge to the desired quotient q. (See Goldschmidt, Robert E., Applications of Division by Convergence, M. Sc. Dissertation, M.I.T, OCLC 3413672, 1964.)

In some cases, it is possible to optimize the performance of an integer division circuit that uses the Goldschmidt method. For example, in the case where the divisor B is equal to zero, the result of the division is undefined. Hence, the division circuit can quickly determine whether B=0, and if so, it can trigger a divide-by-zero trap without executing all of the operations involved in performing the Goldschmidt method. This can save a significant number of computational cycles. Other similar performance optimizations to the Goldschmidt method may be possible.

### SUMMARY

The disclosed embodiments relate to the design of an integer division circuit, which comprises: a dividend-input that receives an integer dividend A; a divisor-input that receives an integer divisor B; a quotient-output that outputs an integer quotient q; and a division engine that executes the Goldschmidt method to divide A by B to produce q. During a pre-processing operation, which commences executing before the Goldschmidt method commences executing, the division engine determines whether A<B. If A<B, the division engine sets q=0 without having to execute the Goldschmidt method.

In some embodiments, during the pre-processing operation, the division engine determines whether B=0. When B=0, the division engine triggers a divide-by-zero trap without having to execute the Goldschmidt method.

In some embodiments, the division circuit is a 64-bit integer division circuit, wherein A, B and q are all 64-bit integers. In these embodiments, during the pre-processing operation, the division engine: determines acnt, which is the number of leading zeros in A; determines bcnt, which is the number of leading zeros in B; and determines ndq, which is the number of bits in q by computing ndq=bcnt acnt+1. When nqd≤27, the division engine skips the iter1 operation while executing the Goldschmidt method. (Note that integer division can be performed on both signed and unsigned operands. For the case of signed operands, the “acnt” and “bcnt” values represent counts of leading zeros after we have two's complemented the corresponding operands A and B if they are negative. So really we are counting the leading zeros for abs(A) and abs(B).)

In some embodiments, during the pre-processing operation, the division engine: determines acnt, which is the number of leading zeros in A; determines bcnt, which is the number of leading zeros in B; and determines from acnt and bcnt whether a remainder computed during the Goldschmidt method is always positive. When the remainder is always positive, the division engine skips a back multiplication (back-mul) operation while executing the Goldschmidt method.

In variations on these embodiments, the division circuit is a 64-bit integer division circuit, wherein A, B and q are all 64-bit integers. In these variations, determining whether the remainder computed during the Goldschmidt method is always positive involves determining whether: acnt≤bcnt; bcnt≠64; and min(max(−bcnt,−62),−54)≤acnt−64.

In some embodiments, during the pre-processing operation, the division engine: determines acnt, which is the number of leading zeros in A; determines bcnt, which is the number of leading zeros in B; and determines ndq, which is the number of bits in q by computing ndq=bcnt acnt+1. When ndq=1, B≤A, and bcnt≠64, the division engine sets q=1 without having to execute the Goldschmidt method.

In some embodiments, if no exception condition arises during the pre-processing operation, the division engine executes the Goldschmidt method without modification. This involves performing the following operations: a table-lookup operation, T=table_lookup(B); a scaling operation, n₀=Aop*T; d₀=Bop*T; r₀=˜d₀, wherein Aop=A*2^{acnt} and Bop=B*2^{bcnt}, and wherein “˜” represents a ones' complement operator; an iter1 operation, n₁=n₀*r₀; d₁=d₀*r₀; r₁=d₁; an iter2 operation, n_{final}=nᵢ*rᵢ+INC, wherein INC comprises a 2M-bit correction constant; a shift-and-truncate operation, q_{trunc}=floor(n_{final}*2^{-(2*M-1)+ndq)}; a back-mul operation, remainder=Bop*q_{trunc}−A; and a rounding operation, if remainder<0 then q_{trunc}−1 else q_{trunc}.

### BRIEF DESCRIPTION OF THE FIGURES

FIG. 1 illustrates an integer division circuit in accordance with the disclosed embodiments.

FIG. 2 illustrates a region where acnt>bcnt in accordance with the disclosed embodiments.

FIG. 3 presents pseudo-code for the Goldschmidt method in accordance with the disclosed embodiments.

FIG. 4 illustrates a region where iter1 can be skipped in accordance with the disclosed embodiments.

FIG. 5 illustrates a region where back-mul can be skipped in accordance with the disclosed embodiments.

FIG. 6 illustrates a region where both iter1 and back-mul can be skipped in accordance with the disclosed embodiments.

FIG. 7 illustrates the resulting regions when all of the optimizations are combined in accordance with the disclosed embodiments.

FIG. 8 presents a flow chart illustrating operations performed by the division circuit in accordance with the disclosed embodiments.

FIG. 9 illustrates a computer system in accordance with an embodiment of the present disclosure.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

### Overview

An integer division circuit can be optimized in a number of different ways. First, there are a number of cases where the result can be computed very quickly. For example, if we can quickly detect B>A or A=0, then the result q=0 can be computed right away, just like the divide-by-zero case, where B=0, which triggers a divide-by-zero trap. Also, if we can quickly determine that the result q is only one bit in size, and that B≠0, then if B>A, then q=0. Otherwise, q=1.

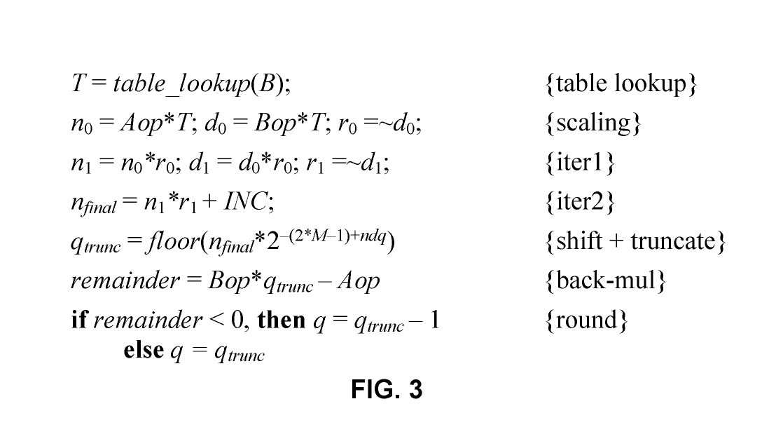

There also exist a number of cases where the integer division circuit can skip major computational steps. For example, suppose the circuit uses the Goldschmidt method, which comprises steps labeled scale, iter1, iter2, and back-mul as is illustrated in FIG. 3. In some cases, it is possible to skip the iter1 and/or back-mul steps, which can significantly reduce the time it takes to perform the division operation. These optimizations are described in more detail below.

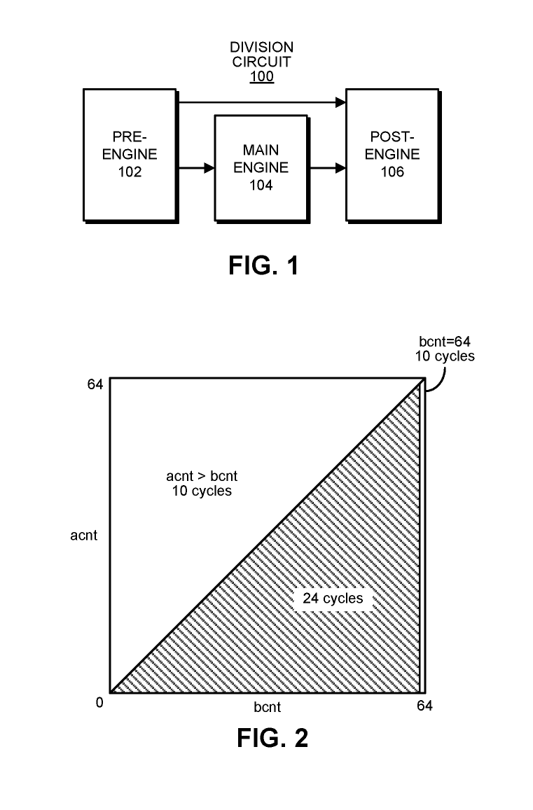

Referring to FIG. 1, at a high level, division circuit 100 includes a pre-engine 102, a main engine 104 and a post-engine 106. In some cases, during a division operation, pre-engine 102 can quickly detect one or more optimizations, which can cause division circuit 100 to skip main engine 104, thereby speeding up execution of the division operation. In other cases, the detected optimizations can enable main engine 104 to skip computational operations, which also speeds up execution of the division operation.

### Implementation Details

We first present a few definitions. An integer division operation computes q=A/B, where we assume that A and B are unsigned 64-bit integers. (We assume that signed integers have already been converted to unsigned integers.) A number of quantities are defined below.

acnt=number of leading zeros in bit representation of A
bcnt=number of leading zeros in bit representation of B
Aop=2^{acnt}*A, so that Aop has no leading zeros
Bop=2^{bcnt}*B, so that Bop has no leading zeros
ndq=bcnt−acnt+1

For many cases, ndq represents the number of bits in the quotient q.

A first optimization for integer division can be performed by means of a full comparison between A and B. As noted above, if we can quickly detect B>A or A=0, then the result q=0 can be computed in 10 cycles in an exemplary implementation, just like the case B=0.

A number of alternative optimizations can be implemented through conditions on acnt and bcnt. Using the definition of acnt and bcnt, we can indicate for each choice of (bcnt, acnt) how many cycles an integer division takes. For example, if bcnt=64, then B=0, and an exemplary implementation produces a result “divide-by-zero” trap after 10 cycles. In another example, if bcnt<acnt, then B>A and integer division should produce 0 as a result. Note that the case bcnt<acnt includes the case where a=0 and b≠0. The division circuit can quickly detect such cases and produce a default result of 0 after 10 cycles in the exemplary implementation. If acnt=bcnt and A≥B, then result 1 can be produced after 10 cycles. For all other cases, i.e., bcnt>acnt and bcnt≠64, the exemplary implementation takes 24 cycles to produce a result.

FIG. 2 illustrates the number of cycles required by the current implementation as a function of acnt and bcnt. Note that a default result of 0 applies when acnt>bcnt, and a divide-by-zero trap occurs when bcnt=64, i.e., B=0. These default cases take 10 cycles in the exemplary implementation. When acnt=bcnt and A<B, then the result of 0 also applies. When acnt=bcnt and A≥B, then the result of 1 applies. All other cases take 24 cycles.

### The Goldschmidt Method

To explain the next optimizations, we first describe the basic steps of the Goldschmidt method. The idea behind the Goldschmidt method for integer division is as follows. In order to compute q=A/B, the implementation first computes an approximation to

q1=Aop/Bop=(A/B)*2acnt−bcnt=(A/B)*2^{1-ndq},

and then shifts this approximation by the appropriate number of bits to obtain the right number of non-fractional bits in the quotient. Subsequently, the shifted approximation is rounded.

We assume that Aop and Bop are M-bit integers with a leading bit 1, where M=68 in our implementation. To compute Aop/Bop, the method calculates a series of M-bit numbers T and rᵢ, for i≥0, such that (((Bop*T)*r₀)*r₁) . . . converges to the M-bit result 2^{M-1} Then (((Aop*T)*r₀)*r₁) . . . converges to 2^{M-1}*q1, because

$$q 1 = \frac{Aop}{Bop} = \frac{( ( ( Aop * T ) * {r}_{0} ) * {r}_{1} ) * …}{( ( ( Bop * T ) * {r}_{0} ) * {r}_{1} ) * …} \to \frac{( ( ( Aop * T ) * {r}_{0} ) * {r}_{1} ) * …}{{2}^{M - 1}}$$

wherein the first factor T comes from a table lookup and is an initial estimate of 2^{2M-1}/Bop. The other factors rᵢ are also easily computed by performing a ones' complement of the denominator dᵢ, indicated by ˜dᵢ. To avoid big numbers in the implementation, each multiplication “*” is implemented as a 2M-bit result that is truncated to the highest M bits.

More specifically, FIG. 3 illustrates the basic Goldschmidt method. Recall that each multiplication in steps scaling and iter1 is an M-bit multiplication where the 2M-bit result is truncated to the high M bits. The result n_{final}, however, remains a 2M-bit result. For our implementation, we have proved that n_{final}<2^{2M-1}, i.e., the leading bit of n_{final} is always 0.

Steps scaling, iter1 and iter2 compute an approximation nᵢ of 2^{M-1}*q1. The accuracy in the approximation doubles with each step. The shift-and-truncate step shifts n_{final} and then truncates the result to the proper number of integer bits. The multiplication n_{final}*2^{-(2M-1)+ndq} yields a number with ndq non-fractional bits. The step back-mul only serves to compute the sign of the remainder. The final rounding step rounds the result based on the sign of the remainder. If the remainder is negative, q_{trunc} is decremented by 1 to get the result; otherwise, no decrementing takes place.

In step iter2 the method adds a special 2M-bit correction constant INC. The current implementation for integer division uses the value M=68 and

INC[135:0]=2^{134+c}−2⁶⁹

with c=min(max(−62,−bcnt),−54), i.e., c is the value bcnt clamped to the interval [−62,−54]. Note that when we eliminate the step iter1, we have to change the INC constant.

Eliminating Iter1

When the number of digits in the quotient ndq satisfies

1≤ndq≤27 and bcnt≠64

we can skip step iter1 and immediately go to step iter2 (with substitution n₁, r₁=n₀, r₀) followed by the back multiplication and rounding. In an exemplary implementation, skipping step iter1 saves 4 cycles. This leads to 20 cycles total for integer division. The condition 1≤ndq≤27 means that the integer result has at least 1 and at most 27 bits. (A brief proof is presented at the end of this section.)

When skipping step iter1, the value for INC must be changed to

INC[135:0]=2¹⁰⁸−2¹⁰⁵.

This value for INC can be used also for single-precision, floating-point division, which skips step iter1 as well, and can be used for single-precision, floating-point square root, which has a similar correction constant.

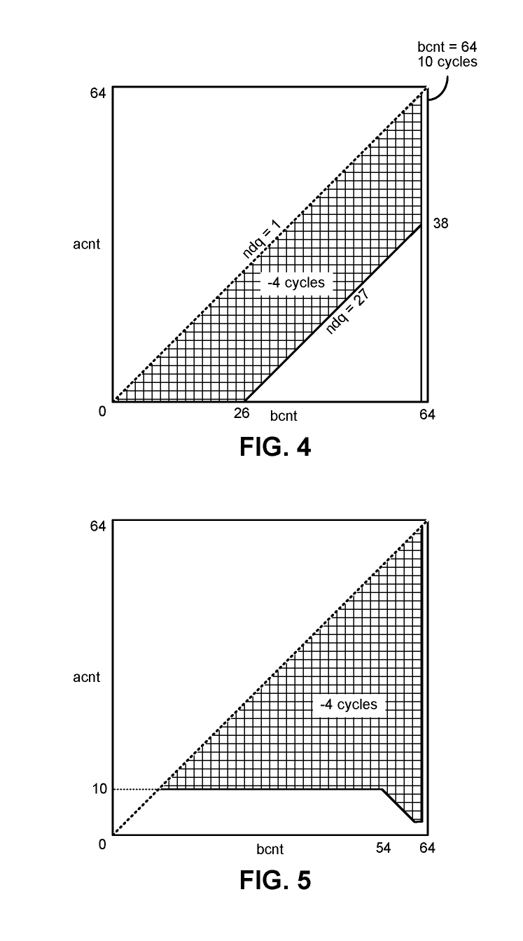

FIG. 4 illustrates the region in the (acnt, bcnt) plane where we can save 4 cycles of an integer division in the exemplary implementation.

### Eliminating Back-Mul

Under certain conditions we can skip the back multiplication operation back-mul, because the remainder will always be positive and no decrement needs to be done in the rounding step. In these cases rounding amounts to simply taking q=q_{trunc} Although we can eliminate the rounding step as well as the back multiplication step, we will leave the rounding step in the method, because rounding in the exemplary implementation may include some other computations that cannot always be eliminated (e.g., conversion from unsigned to signed). In the exemplary implementation, the elimination of the back-mul step saves 4 cycles and leads to 20 cycles total for an integer division. (A brief proof is presented at the end of this section.)

back-mul can be skipped when

acnt≤bcnt and bcnt≠64 and
min(max(−bcnt,−62),−54)≤acnt−64
or in slightly simpler terms, when
bcnt≤acnt and bcnt≠64 and
(acnt≥10 when 0≤bcnt≤54

acnt≥64−bcnt when 54≤bcnt≤62

acnt≥2 when 62≤bcnt≤63).

For elimination of the back multiplication, the value for INC remains as specified previously INC [135:0]=2^{134+c}−2⁶⁹ with c−min(max(−62,−bcnt),−54).

FIG. 5 illustrates regions where back multiplication can be eliminated as a function of acnt and bcnt.

### Combining Optimizations

When 38≤acnt≤bcnt and bcnt≠64, we can skip both iter1 and back-mul. (A proof is presented at the end of this section.) This case requires the following value for INC

INC[135:0]=2¹⁰⁸−2¹⁰⁵.

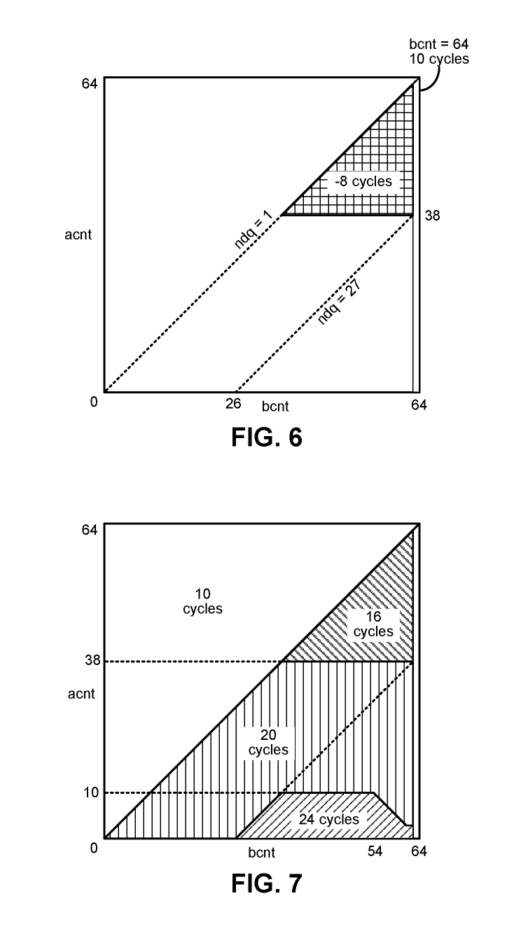

FIG. 6 illustrates the combination of two optimizations. Note that in this region the operands A and B as well as the result have at most 27 bits.

### Putting Everything Together

FIG. 7 illustrates the combination of all of the optimizations, and the resulting number of cycles of an integer division as a function of acnt and bcnt. Note that the region with a latency of 20 cycles is basically an overlap of two regions where in each region a different optimization is applied, either skip iter1 or skip back-mul, but not both.

By using the above-described optimizations, the exemplary implementation can perform an integer division operation in 10, 16, 20, or 24 cycles depending on the values of acnt and bcnt. In some strategically important workloads, there are surprisingly many integer divisions with small inputs or small results, i.e., at most 27 bits. Many of these integer divisions are part of the region where an integer division can be done in 20 or even 16 cycles.

### Proof for Skipping Iter1

The Goldschmidt method computes a 2M-bit approximation n_{final}, which has a leading bit 0. For our implementation M=68. The value 2⁻¹³⁴*n_{final} is an approximation for q1, where q1=Aop/Bop=(A/B)*2^{1-ndq}. Assume that for the Goldschmidt method we can prove

0<2⁻¹³⁴*n_{final}q1<UB (1)

for some value of UB. Then multiplying with 2^{ndq-1}, we have

0<2^{-134+ndq-1}*n_{final}−2^{ndq-1}*q1<2^{ndq-1}*UB.

After truncating and using q_{trunc}=floor(n_{final}*2^{-134+ndq-1}) as well as 2^{ndq-1}*q1=A/B, we get

1<q_{trunc}−A/B<2^{ndq-1}*UB (2).

When we skip step iter1, we can prove property (1) for UB=2⁻²⁶ and using INC[135:0]=2¹⁰⁸−2¹⁰⁵.

Hence, when ndq≤27, we can use (2) and 2^{ndq-1}*UB≤2²⁷⁻¹*2⁻²⁶=1 to prove that −1<q_{trunc}−A/B<1, which is the necessary condition to guarantee proper rounding.

For the Goldschmidt method that skips step iter1, we could not find a proof for (1) with the smaller upper bound of UB=2⁻²⁷, unless we change the lookup tables. This suggests that UB=2⁻²⁶ is the smallest upper bound we can find for (1) when skipping step iter1.

### Proof for Skipping Back-Mul

Recall that the basic division method computes the value n_{final}[135:0] with error bounds

≤2⁻¹³⁴*n_{final}−q1<2^{c} (3)

where c=min(max(−bcnt,−62),−54) and q1=Aop/Bop=(A/B)*2^{acnt-bcnt}. After rewriting (3), we obtain q1≤2⁻¹³⁴*n_{final}<q1+2^{c}. Substituting the definition of q1 we get

(A/B)*2^{acnt-bcnt}≤2⁻¹³⁴*n_{final}≤(A/B)*2^{acnt-bcnt}+2^{c}

or

A/B≤n_{final}*2^{-134-acnt+bcnt}<A/B+2^{c-acnt+bcnt}.

If c≤acnt−64, then

A/B+2^{c-acnt+bcnt}

≤A/B+2^{-64+bcnt} (because c≤acnt−64)

=A/B+½^{64-bcnt}

<A/B+1/B (because 2^{64-bcnt}>B)

=(A+1)/B.

In other words, when c≤acnt−64, then A/B≤n_{final}*2^{-134-acnt+bcnt}<(A+1)/B, where n_{final}*2^{-134-acnt+bcnt}=n_{final}*2^{-134+ndq-1}. For integers A and B, there is no integer in the open segment (A/B, (A+1)/B). Hence, for any xϵ(A/B,(A+1)/B), truncating x gives the same result as truncating A/B. In other words,

floor(A/B)=floor(n_{final}*2^{-134-acnt+bcnt})=q_{trunc}.

The condition c≤acnt−64 is the same as min(max(−bcnt,−62),−54)≤acnt−64.

### Proof for Skipping Iter1 and Back-Mul

When we skip step iter1 in the Goldschmidt method, we can prove

0<2⁻¹³⁴*n_{final}−q1<2⁻²⁶.

(This assumes using a value of INC=2¹⁰⁸−2¹⁰⁵ when computing n_{final}.) Using the same reasoning as in the previous proof, but now with c=−26, we derive that if −26≤acnt−64, then

A/B≤n_{final}*2^{-134+ndq-1}<(A+1)/B.

As in the previous proof, we can again conclude that for any xϵ(A/B,(A+1)/B), truncating x gives the same result as truncating A/B. In other words,

floor(A/B)=floor(n_{final}*2^{-134+ndq-1})=q_{trunc}.

Because the sign of the remainder is not important for the truncation, we can skip back-mul as well as iter1 when −26≤acnt−64 and acnt≤bcnt, or when 38≤acnt≤bcnt.

### Operation of Division Circuit

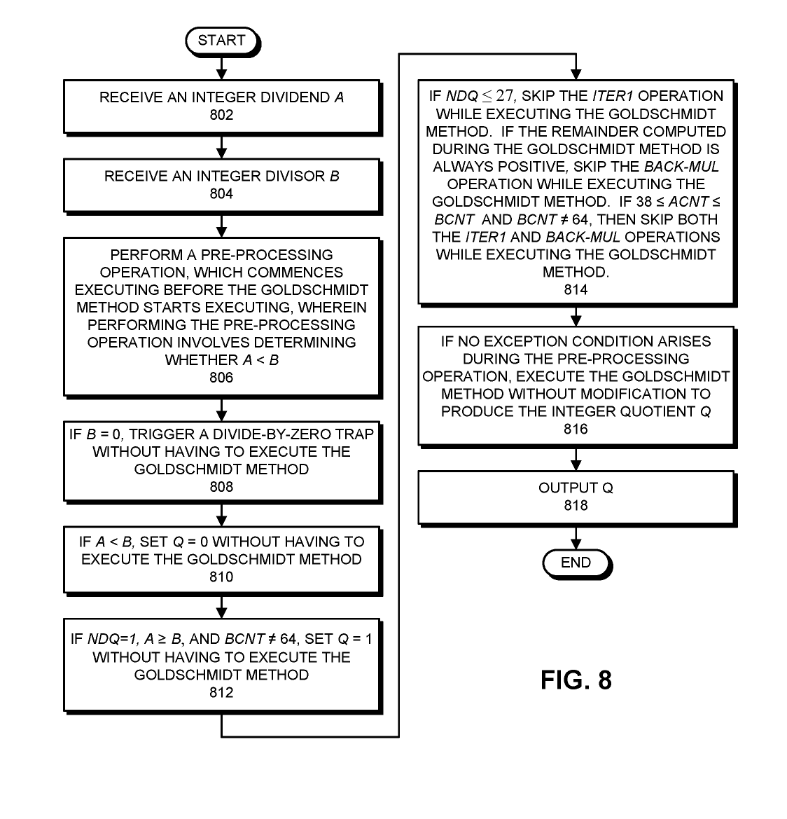

FIG. 8 presents a flow chart illustrating operations performed by a system that comprises a division circuit in accordance with the disclosed embodiments. First, the system receives an integer dividend A (step 802) and an integer divisor B (step 804). Next, the system performs a pre-processing operation, which commences executing before the Goldschmidt method starts executing, wherein performing the pre-processing operation involves determining whether A<B (step 806). If B=0, the system triggers a divide-by-zero trap without having to execute the Goldschmidt method (step 808). If A<B, the system sets q=0 without having to execute the Goldschmidt method (step 810). Additionally, if ndq=1, A≥13 and bcnt≠64, the system sets q=1 without having to execute the Goldschmidt method (step 812).

As mentioned above, other optimizations involve modifying the Goldschmidt method. If ndq≤27, the system skips an iter1 operation while executing the Goldschmidt method (step 814). If the remainder computed during the Goldschmidt method is always positive, the system skips the back-mul operation while executing the Goldschmidt method (step 814). If 38≤acnt≤bcnt and bcnt≠64, then both computation steps iter1 and back-mul can be skipped (step 814).

Next, if no exception condition arises during the pre-processing operation, the system executes the Goldschmidt method without modification to produce an integer quotient q (step 818). Finally, the system outputs q (step 820).

### System

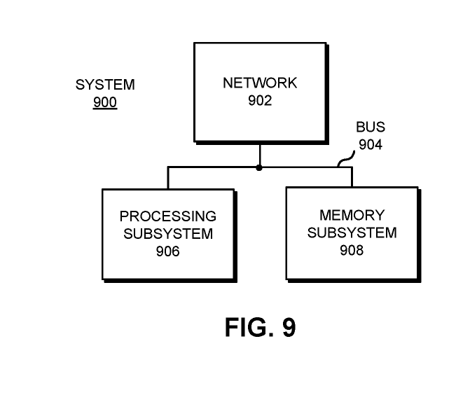

One or more of the preceding embodiments of the integer division circuit may be included in a system or device. More specifically, FIG. 9 illustrates a system 900 that includes a network 902 and a processing subsystem 906 comprising one or more processors (which include an integer division circuit) and a memory subsystem 908 comprising a random-access memory.

In general, components within system 900 may be implemented using a combination of hardware and/or software. Thus, system 900 may include one or more program modules or sets of instructions stored in a memory subsystem 908 (such as DRAM or another type of volatile or non-volatile computer-readable memory), which, during operation, may be executed by processing subsystem 906. Furthermore, instructions in the various modules in memory subsystem 908 may be implemented in: a high-level procedural language, an object-oriented programming language, and/or in an assembly or machine language. Note that the programming language may be compiled or interpreted, e.g., configurable or configured, to be executed by the processing subsystem.

Components in system 900 may be coupled by signal lines, links or buses, such as bus 904. These connections may include electrical, optical, or electro-optical communication of signals and/or data. Furthermore, in the preceding embodiments, some components are shown directly connected to one another, while others are shown connected via intermediate components. In each instance, the method of interconnection, or “coupling,” establishes some desired communication between two or more circuit nodes, or terminals. Such coupling may often be accomplished using a number of photonic or circuit configurations, as will be understood by those of skill in the art; for example, photonic coupling, AC coupling and/or DC coupling may be used.

In some embodiments, functionality in these circuits, components and devices may be implemented in one or more: application-specific integrated circuits (ASICs), field-programmable gate arrays (FPGAs), and/or one or more digital signal processors (DSPs). Furthermore, functionality in the preceding embodiments may be implemented more in hardware and less in software, or less in hardware and more in software, as is known in the art. In general, system 900 may be at one location or may be distributed over multiple, geographically dispersed locations.

System 900 may include: a switch, a hub, a bridge, a router, a communication system (such as a wavelength-division-multiplexing communication system), a storage area network, a data center, a network (such as a local area network), and/or a computer system (such as a multiple-core processor computer system). Furthermore, the computer system may include, but is not limited to: a server (such as a multi-socket, multi-rack server), a laptop computer, a communication device or system, a personal computer, a work station, a mainframe computer, a blade, an enterprise computer, a data center, a tablet computer, a supercomputer, a network-attached-storage (NAS) system, a storage-area-network (SAN) system, a media player (such as an MP3 player), an appliance, a subnotebook/netbook, a tablet computer, a smartphone, a cellular telephone, a network appliance, a set-top box, a personal digital assistant (PDA), a toy, a controller, a digital signal processor, a game console, a device controller, a computational engine within an appliance, a consumer-electronic device, a portable computing device or a portable electronic device, a personal organizer, and/or another electronic device.

Moreover, network 902 can be used in a wide variety of applications, such as: communications (for example, in a transceiver, an optical interconnect or an optical link, such as for intra-chip or inter-chip communication), a radio-frequency filter, a biosensor, data storage (such as an optical-storage device or system), medicine (such as a diagnostic technique or surgery), a barcode scanner, metrology (such as precision measurements of distance), manufacturing (cutting or welding), a lithographic process, data storage (such as an optical-storage device or system) and/or entertainment (a laser light show).

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. An integer division circuit, comprising:
a dividend-input that receives an integer dividend A;
a divisor-input that receives an integer divisor B;
a quotient-output that outputs an integer quotient q; and
a division engine that executes a Goldschmidt method to divide A by B to produce q;
wherein during a pre-processing operation, which commences executing before the Goldschmidt method commences executing, the division engine determines whether A<B; and
when A<B, the division engine sets q=0 without having to execute the Goldschmidt method.

2. The integer division circuit of claim 1,
wherein during the pre-processing operation, the division engine determines whether B=0; and
when B=0, the division engine triggers a divide-by-zero trap without having to execute the Goldschmidt method.

3. The integer division circuit of claim 1,
wherein the division circuit is a 64-bit integer division circuit, wherein A, B and q are all 64-bit integers; and
wherein during the pre-processing operation, the division engine:
determines acnt, which is the number of leading zeros in A;
determines bcnt, which is the number of leading zeros in B;
determines ndq, which is the number of bits in q by computing ndq=bcnt−acnt+1; and
when ndq≤27, skips an iter1 operation while executing the Goldschmidt method.

4. The integer division circuit of claim 1,
wherein during the pre-processing operation, the division engine:
determines acnt, which is the number of leading zeros in A;
determines bcnt, which is the number of leading zeros in B;
determines from acnt and bcnt whether a remainder computed during the Goldschmidt method is always positive; and
when the remainder is always positive, the division engine skips a back-mul operation while executing the Goldschmidt method.

5. The integer division circuit of claim 4,
wherein the division circuit is a 64-bit integer division circuit, wherein A, B and q are all 64-bit integers; and
wherein determining whether the remainder computed during the Goldschmidt method is always positive involves determining whether:
acnt≤bcnt;
bcnt≠64; and
min(max(−bcnt,−62),−54)≤acnt−64.

6. The integer division circuit of claim 1,
wherein during the pre-processing operation, the division engine:
determines acnt, which is the number of leading zeros in A;
determines bcnt, which is the number of leading zeros in B;
determines ndq, which is the number of bits in q by computing ndq=bcnt−acnt+1; and
when ndq=1, A≥B, and bcnt≠64, the division engine sets q=1 without having to execute the Goldschmidt method.

7. The integer division circuit of claim 1, wherein if no exception condition arises during the pre-processing operation, the Goldschmidt method executes without modification, which involves performing the following operations:
a table-lookup operation, T=table_lookup(B);
a scaling operation, n₀=Aop*T; d₀=Bop*T; r₀=˜d₀, wherein Aop=A*2^{acnt} and Bop=B*2^{bcnt}, and wherein “˜” represents a ones' complement operator;
an iter1 operation, n₁=n₀*r₀; d₁=d₀*r₀; r₁=˜d₁;
an iter2 operation, n_{final}=n₁+r₁+INC, wherein INC comprises a 2M-bit correction constant;
a shift-and-truncate operation, q_{trunc}=floor(n_{final}*2^{-(2*M-1)+ndq});
a back-mul operation, remainder=Bop*q_{trunc}−A; and
a rounding operation, if remainder<0 then q_{trunc}−1 else q_{trunc}.

8. A system, comprising:
a processor; and
a memory coupled to the processor;
wherein the processor includes an integer division circuit, comprising:
a dividend-input that receives an integer dividend A;
a divisor-input that receives an integer divisor B;
a quotient-output that outputs an integer quotient q; and
a division engine that executes a Goldschmidt method to divide A by B to produce q;
wherein during a pre-processing operation, which commences executing before the Goldschmidt method commences executing, the division engine determines whether A<B; and
when A<B, the division engine sets q=0 without having to execute the Goldschmidt method.

9. The system of claim 8,
wherein during the pre-processing operation, the division engine determines whether B=0; and
when B=0, the division engine triggers a divide-by-zero trap without having to execute the Goldschmidt method.

10. The system of claim 8,
wherein the division circuit is a 64-bit integer division circuit, wherein A, B and q are all 64-bit integers; and
wherein during the pre-processing operation, the division engine:
determines acnt, which is the number of leading zeros in A;
determines bcnt, which is the number of leading zeros in B;
determines ndq, which is the number of bits in q by computing ndq=bcnt−acnt+1; and
when ndq≤27, skips an iter1 operation while executing the Goldschmidt method.

11. The system of claim 8,
wherein during the pre-processing operation, the division engine:
determines acnt, which is the number of leading zeros in A;
determines bcnt, which is the number of leading zeros in B;
determines from acnt and bcnt whether a remainder computed during the Goldschmidt method is always positive; and
when the remainder is always positive, the division engine skips a back-mul operation while executing the Goldschmidt method.

12. The system of claim 11,
wherein the division circuit is a 64-bit integer division circuit, wherein A, B and q are all 64-bit integers; and
wherein determining whether the remainder computed during the Goldschmidt method is always positive involves determining whether:
acnt≤bcnt;
bcnt≠64; and
min(max(−bcnt,−62),−54)≤acnt−64.

13. The system of claim 8,
wherein during the pre-processing operation, the division engine:
determines acnt, which is the number of leading zeros in A;
determines bcnt, which is the number of leading zeros in B;
determines ndq, which is the number of bits in q by computing ndq=bcnt−acnt+1; and
when ndq=1, acnt≤bcnt, and bcnt≠64, the division engine sets q=1 without having to execute the Goldschmidt method.

14. The system of claim 8, wherein if no exception condition arises during the pre-processing operation, the Goldschmidt method executes without modification, which involves performing the following operations:
a table-lookup operation: T=table_lookup(B);
a scaling operation: n₀=Aop*T; d₀=Bop*T; r₀=˜d₀, wherein Aop=2^{acnt} and Bop=2^{bcnt}, and wherein “˜” represents a ones' complement operator;
an iter1 operation: n₁=n₀*r₀; d₁=d₀*r₀; r₁=˜d₁;
an iter2 operation: n_{final}=n₁*r₁+INC, wherein INC comprises a 2M-bit correction constant;
a shift-and-truncate operation: q_{trunc}=floor(n_{final}*2^{-(2*M-1)+ndq});
a back-mul operation: remainder=Bop*q_{trunc}−A; and
a rounding operation: if remainder<0, then q_{trunc}−1 else q_{trunc}.

15. A method for performing an integer division operation, comprising:
receiving an integer dividend A;
receiving an integer divisor B;
performing a pre-processing operation, which commences executing before the method executes a Goldschmidt method, wherein performing the pre-processing operation involves determining whether A<B;
when A<B, setting the integer quotient q=0 without having to execute the Goldschmidt method;
if no exception condition arises during the pre-processing operation, executing the Goldschmidt method without modification to produce q; and
outputting q.

16. The method of claim 15,
wherein performing the pre-processing operation involves determining whether B=0; and
when B=0, triggering a divide-by-zero trap without having to execute the Goldschmidt method.

17. The method of claim 15,
wherein the division circuit is a 64-bit integer division circuit, wherein A, B and q are all 64-bit integers;
wherein performing the pre-processing operation involves performing the following operations:
determining acnt, which is the number of leading zeros in A;
determining bcnt, which is the number of leading zeros in B;
determining ndq, which is the number of bits in q by computing ndq=bcnt−acnt+1; and
when ndq≤27, skipping an iter1 operation while executing the Goldschmidt method.

18. The method of claim 15,
wherein performing the pre-processing operation involves performing the following operations:
determining acnt, which is the number of leading zeros in A;
determining bcnt, which is the number of leading zeros in B;
determining from acnt and bcnt whether a remainder computed during the Goldschmidt method is always positive; and
when the remainder is always positive, skipping a back-mul operation while executing the Goldschmidt method.

19. The method of claim 18,
wherein the division circuit is a 64-bit integer division circuit, wherein A, B and q are all 64-bit integers; and
wherein determining whether the remainder computed during the Goldschmidt method is always positive involves determining whether:
acnt≤bcnt;
bcnt≠64; and
min(max(−bcnt,−62),−54)≤acnt−64.

20. The method of claim 15,
wherein performing the pre-processing operation involves performing the following operations:
determining acnt, which is the number of leading zeros in A;
determining bcnt, which is the number of leading zeros in B;
determining ndq, which is the number of bits in q by computing ndq=bcnt−acnt+1; and
when ndq=1, A≥B, and bcnt≠64, setting q=1 without having to execute the Goldschmidt method.
